(19) United States
(12) Patent Application Publication
(10) Pub. No.: US 2012/0292364 A1
(43) Pub. Date: Nov. 22, 2012

(54) MEAT TRUSSING SYSTEM

(75) Inventors: Daniel Droz, Pittsburgh, PA (US); Donald G. Sartore, Cranberry Township, PA (US); William L. Sartore, Bethel Park, PA (US)

(73) Assignee: JETNET CORPORATION, Sewickley, PA (US)

(21) Appl. No.: 13/546,903

(22) Filed: Jul. 11, 2012

Related U.S. Application Data
(63) Continuation-in-part of application No. 12/408,885, filed on Mar. 23, 2009, now Pat. No. 8,227,001.

(51) Int. Cl. B65H 35/06; B26F 3/02; B65D 65/22

(52) U.S. Cl. 225/1; 428/43; 428/40.1; 225/77

(57) ABSTRACT

A meat trussing system incorporates the use of an elastomeric net to receive and restrain meats and other food components. At least one flexible wrapper encases the food products forming a cylindrical mass having a low coefficient of friction with respect to the elastomeric net. The wrapper is preferably provided with at least one perforation adapted to be circumferentially disposed near the midpoint of the food products within the elastomeric net. The wrapping sheets are formed in a continuous roll containing a longitudinal perforation. The roll may be disposed within a dispensing device having a cutting tool to allow for the detachment of any number of sheets of a predetermined length.

### CROSS REFERENCE TO RELATED APPLICATION

This application is a continuation in part of U.S. patent application Ser. No. 12/408,885, filed Mar. 23, 2009.

### BACKGROUND OF THE INVENTION

1. Field of the Invention

This invention is directed to a system for wrapping meat and other related products prior to cooking. More specifically, the system relates to an apparatus and method for insertion of a roast or other irregularly shaped food product into a preformed net truss which will receive and restrain the food product during the cooking process.

2. Description of the Prior Art

It is desirable during the cooking of meats and other products to achieve an even and uniform application of heat to the product so that the food product will rise to the desired internal temperature in a uniform manner which is evenly distributed throughout. Unfortunately, most food products and more particularly, most meat products are butchered from naturally occurring muscle groups within the animal such that the meat sections are of unique and irregular geometries. Furthermore, it is sometimes necessary or desirable to combine independent sections of meat or other food products into a single combined mass for cooking. Lastly, it may be desirable to insert other non-uniform food products such as stuffing, vegetables or the like into the meat or other food product and cause the surrounding meat or food products to encompass or encircle the stuffed material during cooking. In each of these situations it is either necessary or desirable to form the meat product into the most uniform mass possible which also may contain the non-uniform or disparate food materials therein. In accordance with the prior art, it is well known to utilize various string or other elongated products, such as butcher's twine, to truss the food products. For the purpose of the remainder of this discussion, the generic term “roast” shall be used to identify all food products which are intended for cooking. It is to be specifically understood that roast shall include meats of all types as well as other non-meat food products which may be unitary in construction or comprised of a variety of independent meat or food components. Roast shall also be deemed to include those products which are rolled or stuffed in order to contain other non-meat products. Additionally, seasonings, flavorings or other additives may be applied to the outside surface of the food products.

Referring now to FIG. 1(a) roast 1 as illustrated in subfigure A is shown having a large roast end 5 and a narrow roast end 10. This is intended to illustrate a typical non-uniform cut of meat which, if cooked in its native form, would cause narrow roast end 10 to achieve a desired internal temperature much more quickly than large roast in 5. The cook is faced with the dilemma of dividing the meat into sections or achieving a desirable internal temperature at large roast end 5 while allowing narrow roast in 10 to be completed comparatively overcooked.

A typical remedy for achieving a more uniform roast geometry is to fold, slice or otherwise manipulate the roast product to create a more uniform shape as shown in subfigure B in which, as an example, narrow roast end 10 has been folded over adjacent large roast end 5. Butcher's twine 15 is wrapped circumferentially around roast 1 in order to restrain the various components or meat portions of roast 1. During the cooking process, as is well known to those skilled in the art, the butcher's twine 15 is manipulated through a series of knots 12 to create a meat truss 20 as shown in subfigure C. While subfigure B specifically illustrates a roast which has been folded and subfigure C illustrates a roast which has been rolled and may be stuffed with stuffing 13, it is also specifically intended that disparate meat components formed of individual meat sections may be combined and trussed with meat truss 20 as well. Flavorings, seasonings or other additives may be applied to the exterior surface.

As is well known to those skilled in the art, the wrapping and trussing of roast 1 is an operation which requires significant dexterity and practice in order to achieve consistent and uniform results. While such trussing may be commonplace among chefs and experienced cooks, for those of lesser skill and experience, this operation presents significant difficulties and in many cases a barrier to the preparation of roasts or food products of this nature.

In commercial or industrial meat packing operations it is also well known to utilize a pre-formed net, which may be elastomeric, to truss meats as illustrated in U.S. Pat. No. 3,477,860, issued Nov. 11, 1969, to M. A. Sartore, entitled “Method for Netting Meat.” This reference illustrates and describes a method and apparatus for providing an elastomeric preformed net which is adapted to receive and restrain the roast product in the desired uniform shape during cooking. The roast is inserted into the net through the use of a rigid preformed funnel which receives and compresses the roast to a size which easily fits within the preformed elastomeric netting. It also permits the easy insertion of the roast into the elastomeric netting by delivering the roast through the narrow end of the funnel into a far end of the elastomeric netting and allowing the movement of the roast through the funnel to draw the remainder of the preformed elastomeric netting across the length of the roast.

A variety of other references include a number of refinements for delivering a roast into such an elastomeric preformed net. Stock, U.S. Pat. No. 3,347,156 issued Oct. 17, 1967, describes an apparatus for preparing a trussed, boned fowl portion which includes the use of a particularly designed spatula which receives and restrains a meat portion already trussed in butcher's twine for insertion into an elastomeric net product. One of the shortcomings of the use of the elastomeric net product is the significant amount of friction encountered while inserting the roast product into the elastomeric net which is typically designed to exert an inward force on the exterior surface of the roast. Because of this design, overexpansion of the elastomeric net is necessary in order to reduce the resistance to the insertion of the roast product into the net. The Stock reference utilizes a preformed rigid frame which is inserted into the elastomeric net and permits the insertion of the roast utilizing the spatula.

The shortcomings of the above approaches to utilization of the elastomeric net product require a significant investment of both equipment and space in order to provide an insertion system for the roast which overcomes the inherent friction created by the elastomeric net. While it is certainly possible to merely force the roast into the net using an individual's hands, this generally defeats the ultimate purpose of creating a uniform and neatly packaged roast which will appear presentable once cooked for slicing and serving.

What is lacking in the art therefore, is a method or apparatus which permits the easy insertion of a roast into an elastomeric net product and which requires little in the way of bulky or expensive equipment unsuitable for home or restaurant use where the investment of such equipment would not be considered appropriate.

### SUMMARY OF THE INVENTION

A meat trussing system is disclosed which enables a low volume, i.e., home or restaurant user to enjoy the benefits of the net truss commonly utilized in commercial or industrial settings in a low volume environment. The system provides that at least one, but also a plurality of low friction wrapping sheets are utilized for encasing the roast product once it has been formed of its individual meat components or rolled with the appropriate fillings or external seasonings. The roast product is assembled on the appropriate wrapping sheet or sheets and the same are circumferentially extended around the entire outer surface of the roast in roughly cylindrical geometry. An adhesive may optionally be provided to permit the sealing or other connection of the ends of the wrapping sheet or sheets in order to form a stable cylindrical mass which requires no further restraint. The wrapping sheets are preferably transparent and formed of a food grade plastic, collagen or other flexible material having a low coefficient of friction but having enough structural integrity and resiliency to receive and restrain the meat products in a relatively compact and tight package. Alternative embodiments may include, however, any material which permits the insertion and removal of the wrapping sheets with respect to the roast material and a net truss, including, waxed and butcher-style papers. The wrapping sheet is preferably provided with a circumferential perforation which is intended to be located roughly near the center of the roast mass. The wrapped roast is then inserted into the net truss product through one of its end openings and the net product is extended longitudinally along the entire length of the roast by sliding over the wrapping sheets. Once the wrapped roast is located entirely within the net truss, the wrapped roast may be bent or otherwise displaced in such a way to cause the circumferential perforation of the wrapping sheets to separate and the now divided wrapping sheets may be removed from their position between the roast and the elastomeric net product by pulling each from the respective ends of the roast inside the net truss. Once removed, the wrapping sheets are discarded and the roast now resides entirely within the net truss product and may be cooked as appropriate.

In an additional embodiment, the wrapping sheets are formed in a continuous roll for easy manufacture and dispensing. The roll is formed such that individual wrappers may be removed. In one embodiment, the roll of wrappers contains perforations to allow for the detachment of any number of sheets of a predetermined length. Additionally, sheets of any desirable length are created by cutting the sheets from the roll with an appropriate cutting instrument. The roll of wrappers may be enclosed within a dispenser. The dispenser contains a cutting instrument located either on the lid or base. The cutting instrument cuts sheets of any desired length from the roll as it exits the dispenser.

### BRIEF DESCRIPTION OF THE DRAWINGS

The aforementioned invention will be appreciated from the following description and accompanying drawings.

FIG. 1 provides a variety of views of a prior art roast.

FIG. 1(a) is a side elevational view of a prior art roast in its native form.

FIG. 1(b) illustrates a prior art roast in the process of being trussed in a side elevational view.

FIG. 1(c) is an isometric figure of a prior art roast encased in a prior art truss.

FIG. 2 provides isometric inside elevational views of a prior art roast in association with a net truss.

FIG. 3 provides an isometric view of a roast in the process of being encased by a first embodiment of the wrapping material.

FIG. 4 provides an isometric view of a roast encased in a second embodiment of the wrapping sheets.

FIG. 4B provides an isometric view of a roast encased in a third embodiment of the wrapping sheets.

FIG. 5 illustrates a top plain view of a first embodiment of the wrapping sheets.

FIG. 5B illustrates a top plan view of a fourth embodiment of the wrapping sheets.

FIG. 6 provides a series of isometric views illustrating the insertion of the wrapped roast into the net truss.

FIG. 7 provides a series of side elevational views of the inserted roast within the net truss.

FIG. 8 illustrates through side elevational views the removal of the wrapping sheets from the roast within the net truss.

FIG. 9 illustrates an isometric view of a roll of wrapping sheets.

FIG. 10 illustrates an isometric view of a roll of interconnected wrapping sheets and perforations.

FIG. 11A illustrates an isometric view of the wrapping sheet dispenser depicted in the open configuration.

FIG. 11B illustrates an isometric view of the wrapping sheet dispenser depicted in the closed configuration.

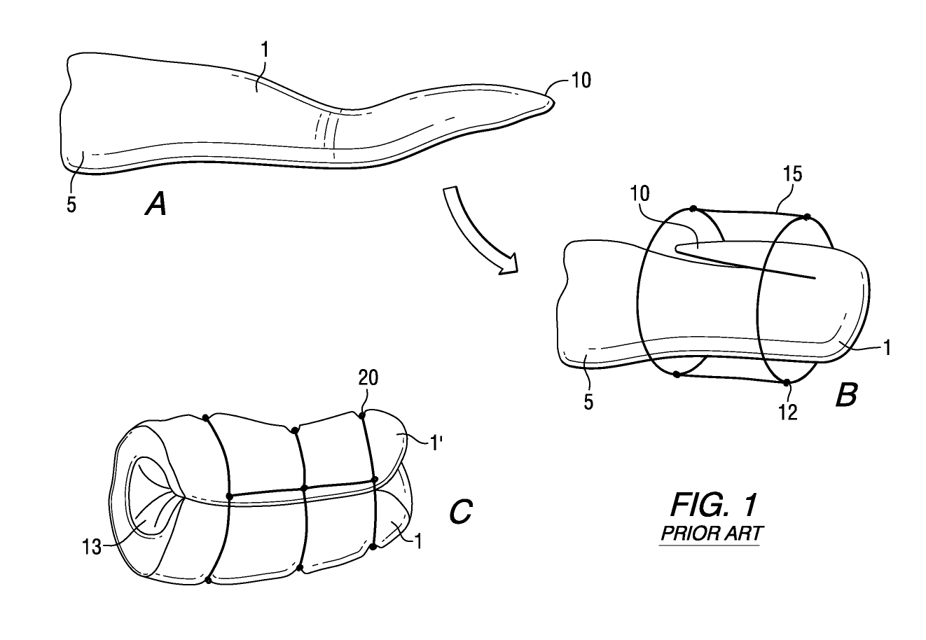

### DETAILED DESCRIPTION OF THE PREFERRED EMBODIMENTS

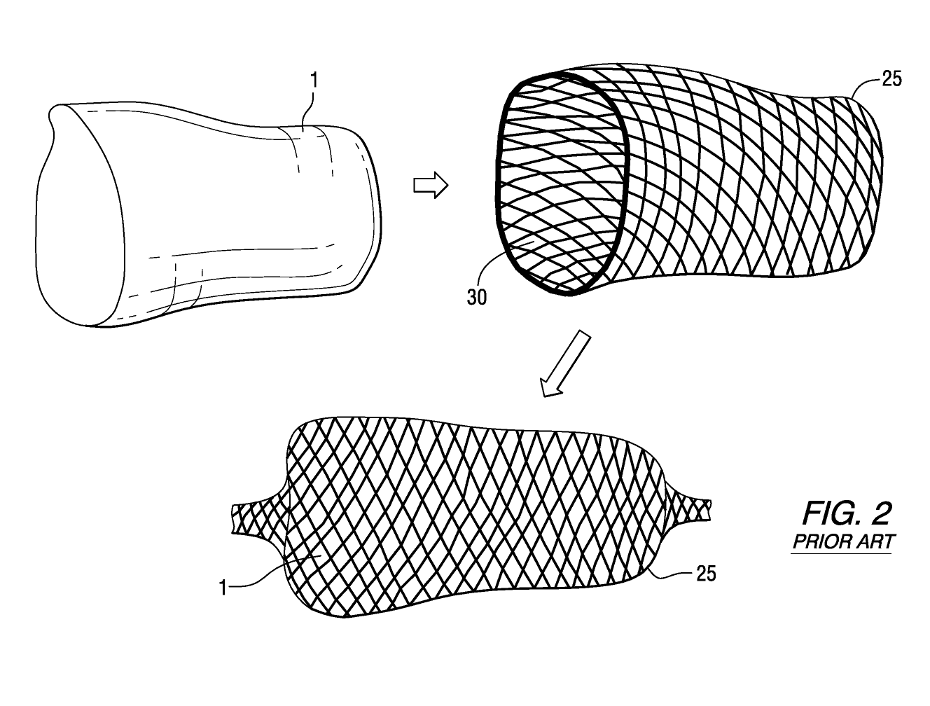

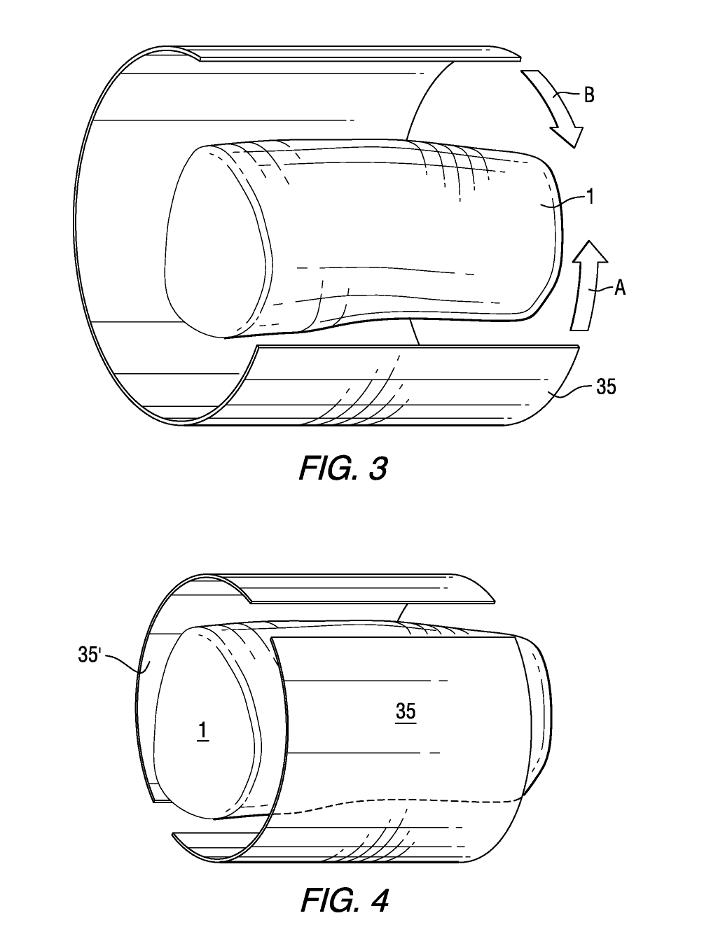

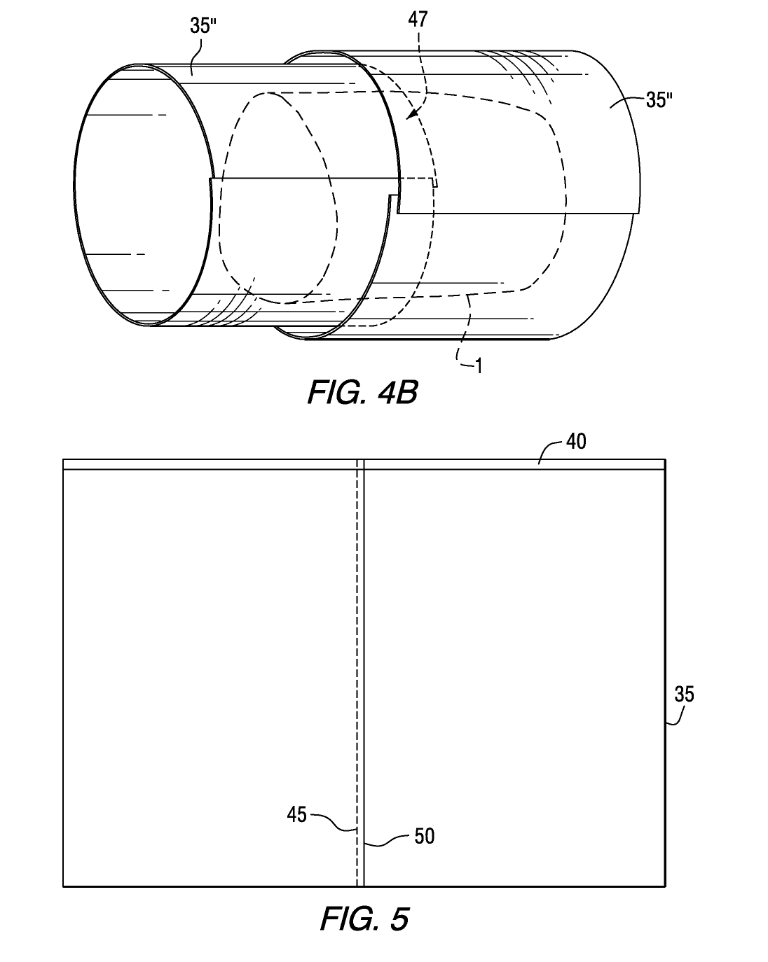

Referring now to FIG. 2, it is a goal of the meat trussing process to insert roast 1 within net truss 25, which is preferably elastomeric, through net truss opening 30 causing the roast to be interposed entirely within net truss 25 as discussed above. The primary impediment to such insertion is the frictional forces exerted upon the roast 1 by elastomeric net 25 during the insertion. Referring now to FIG. 3, roast 1 is inserted and surrounded by wrapper 35. This is typically accomplished by placing wrapper 35 on a counter or other flat surface and assembling the roast and its components thereupon. The ends of wrapper 35 may then be lifted and adjusted circumferentially as shown by arrows A and B to surround the roast material. It is within the skill of those knowledgeable in the art to adapt the roast into any appropriate shape for the ultimate cooking procedure and to further ensure that the wrapper completely encircles the meat product to allow for insertion within the elastomeric netting. As shown in FIG. 4, in the event that the roast is of a particularly large size or at the discretion of the user, a second embodiment including a plurality of wrappers 35 and 35′ may be utilized to circumferentially encircle the roast 1.

Referring now to FIG. 4B, a second embodiment of the wrapping sheets are illustrated which utilize two wrapping sheets 35″ which are longitudinally overlapped forming an overlap zone 47. This overlap zone 47 provides similar functionality as first perforation line 45, allowing selective separation of wrapping sheets 35″ after insertion into elastomeric net 25.

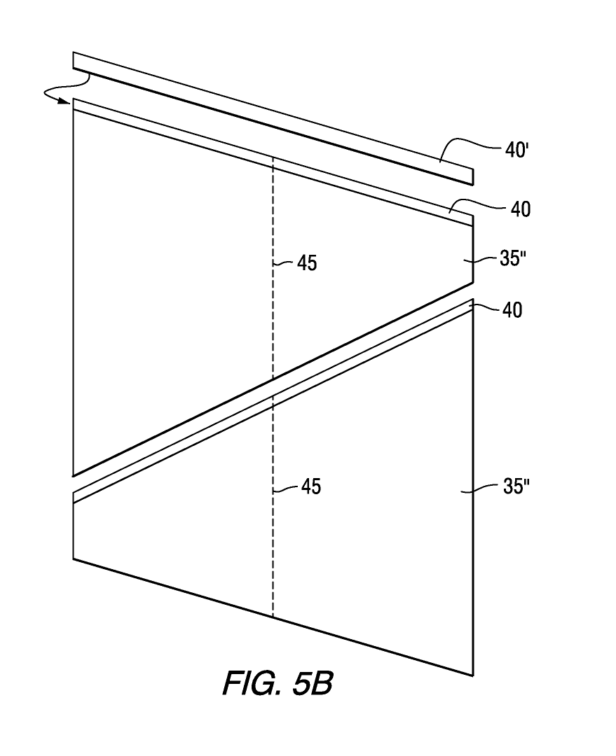

Referring now to FIG. 5, wrapper 35 is illustrated having a number of features all of which are preferred but may be considered optional with minor exceptions. Preferably an adhesive strip 40 is affixed along at least one edge of the wrapper 35 and may optionally be provided with a removable covering (not shown) in order to shield the adhesive material during application. Referring now to FIGS. 3, 4 and 5, the adhesive strip 40 is adapted to facilitate the affixation of the ends of the wrapper or wrappers 35, 35′ and to temporarily restrain wrappers 30, 35′ to the outside surface of the roast 1. Referring now to FIG. 5, wrapper 35 is preferably comprised of a transparent or translucent flexible plastic material of food grade quality such as biaxially oriented polypropylene, cellophane, polyethylene, silicone, coated fabric, Teflon, mylar, vinyl wax or other coated papers or polymers of 0.6-12 mm thickness, and is provided with an adhesive strip 40 along at least one edge for affixing wrapper 35 into a cylindrical shape. While wrapper 35 is shown in a generally rectangular geometry, it is specifically contemplated that the shape of the wrapper 35 may be of any particular shape or dimension and adapted to the particular application. A fourth embodiment of the wrappers 35′″ are illustrated in FIG. 5B, having a trapezoidal geometry for forming a cone encasing roast 1. Referring again to FIGS. 5 and 5B, wrapper 35 is provided with first perforation line 45 which is typically aligned at the midpoint of the wrapper. Reference line 50 is optionally applied to assist the user in locating first perforation line 45 at a point generally central to the mass of the roast 1.

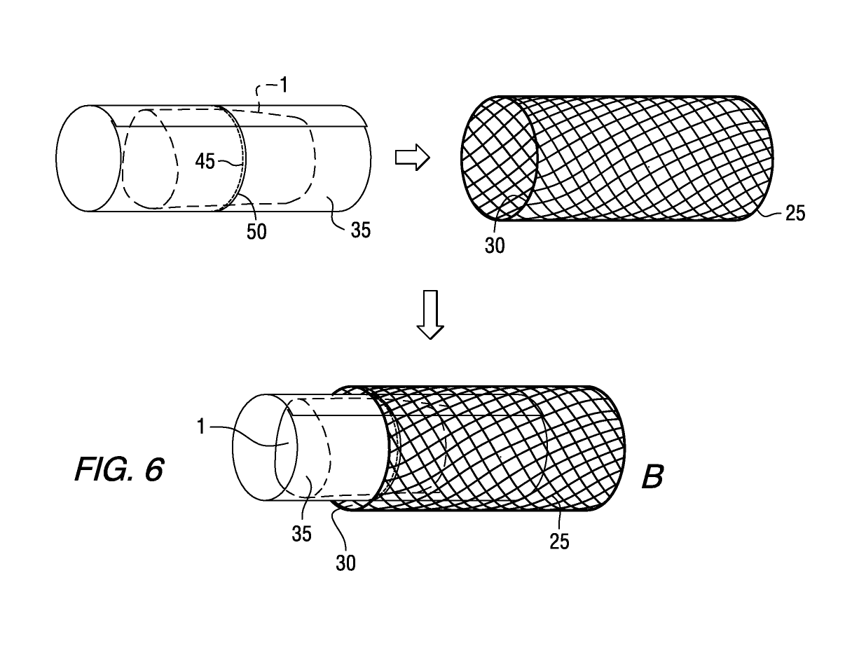

Referring now to FIG. 6, roast 1, shown in chain line, is encircled by wrapper 35 in the generally cylindrical shape identified earlier. Roast 1 is shown as having first perforation line 45 and reference line 50 centrally located along its length. Roast 1 having wrapper 35 attached thereto is positioned for insertion into elastomeric net truss 25 having net truss opening 30 positioned adjacent the end of wrapper 35. In operation the user would extend net truss opening 30 by hand around the edge of wrapper 35 and then slide net truss 25 over the exterior surface of this cylindrically wrapped roast 1. The low coefficient of friction of wrapper 35 permits the easy positioning of net truss 25 along the length of roast 1 having wrapper 35 encircling it. FIG. 6 further illustrates in subfigure B roast 1 almost entirely inserted within elastomeric net 25 with a portion of wrapper 35 extending therefrom through net truss opening 30.

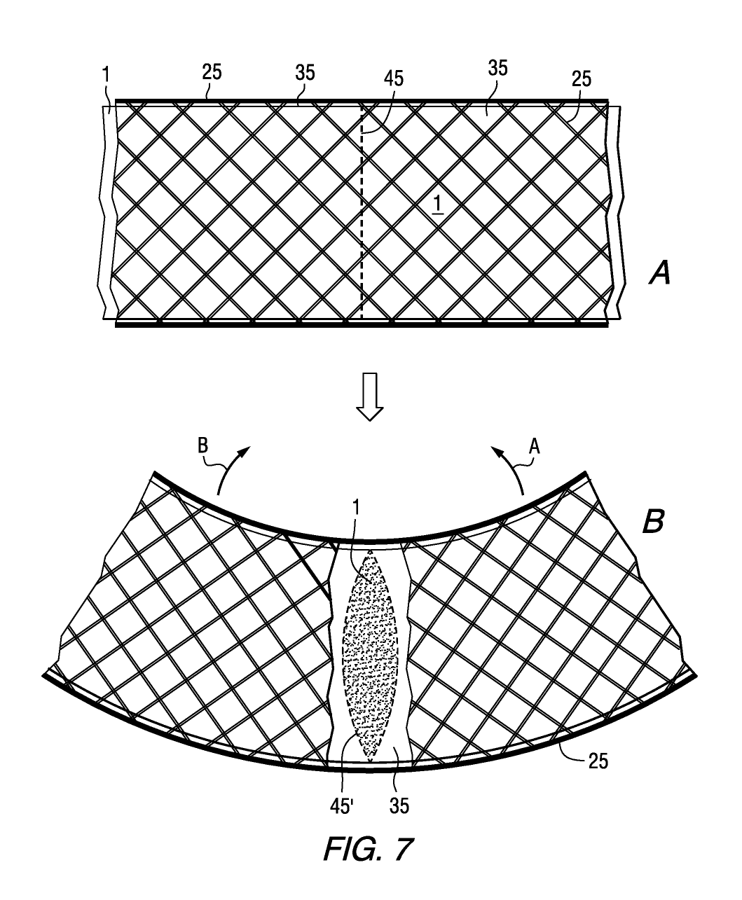

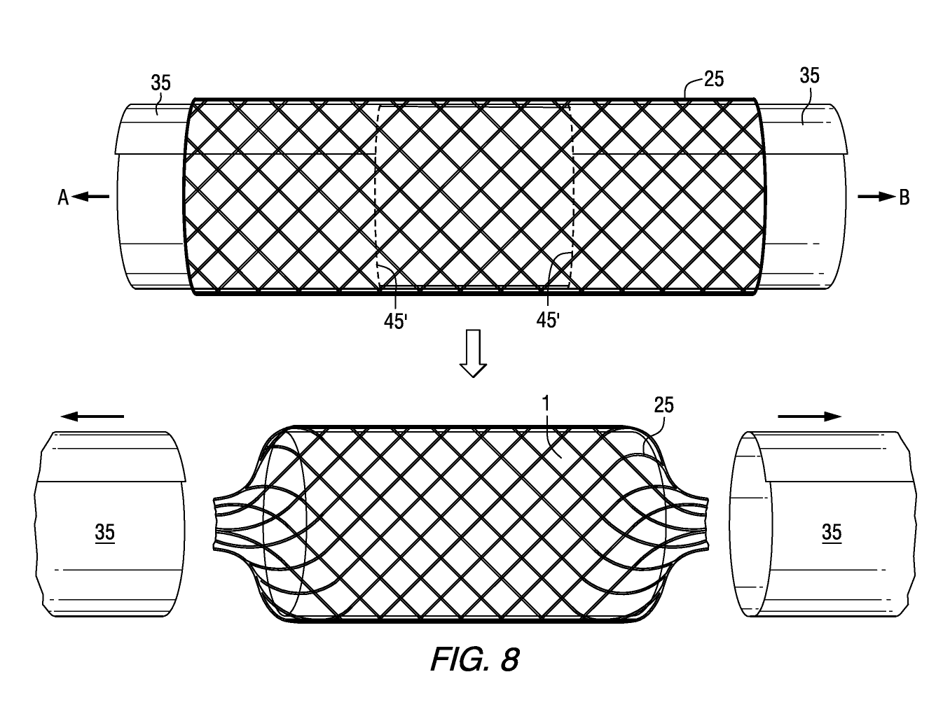

Referring now to FIGS. 6 and 7, roast 1 is positioned within elastomeric net 25 such that at least some portion of wrapper 35 extends outwardly from net truss opening 30 at each end of net truss 25. As show in subfigure A of FIG. 7, elastomeric net truss 25 is positioned along the length of roast 1 and in light of its compressive feature once released by the user is in close conformation with roast 1 having wrapper 35 surrounding it. Referring to FIG. 7(B) and FIG. 8, roast 1 is physically deformed or deflected by the user through the flexion of roast 1 in an arcuate manner causing longitudinal stress to be exerted along one side of roast 1 and more particularly with respect to wrapper 35 at first perforation line 45. This force, when exerted to a degree sufficient to separate first perforation line 45, is illustrated in FIG. 7(B). Alternatively, if roast 1 is too large or otherwise shaped so as to limit the longitudinal deflection in an arcuate manner sufficient to separate the wrapper 35 along first perforation line 45, vertical or other compressive pressure may be exerted with the user's fingers or another implement to cause first perforation line 45 to break, thereby separating the wrapper 35 into two sections without need for longitudinal deflection.

At this point, roast 1 may be manipulated by the user to cause first perforation line 45 to separate along its entire circumferential length thus separating wrapper 35 into two separate pieces having perforated edges 45′. Each of these separate pieces as shown in FIG. 6 (B) and FIG. 8 extends slightly outside of net truss 25 through net truss opening 30. The user may then grasp the extending edges of wrapper 35 from net truss 25 and slide each of the two halves of wrapper 35 outwardly from around roast 1 inside elastomeric net 25. The particular design of wrapper 35 incorporating materials having a low coefficient of friction with respect to elastomeric net 25 and roast 1 permits the easy removal of these wrapper halves without undue exertion and it is specifically designed to be within the strength and ability of a typical home or restaurant user.

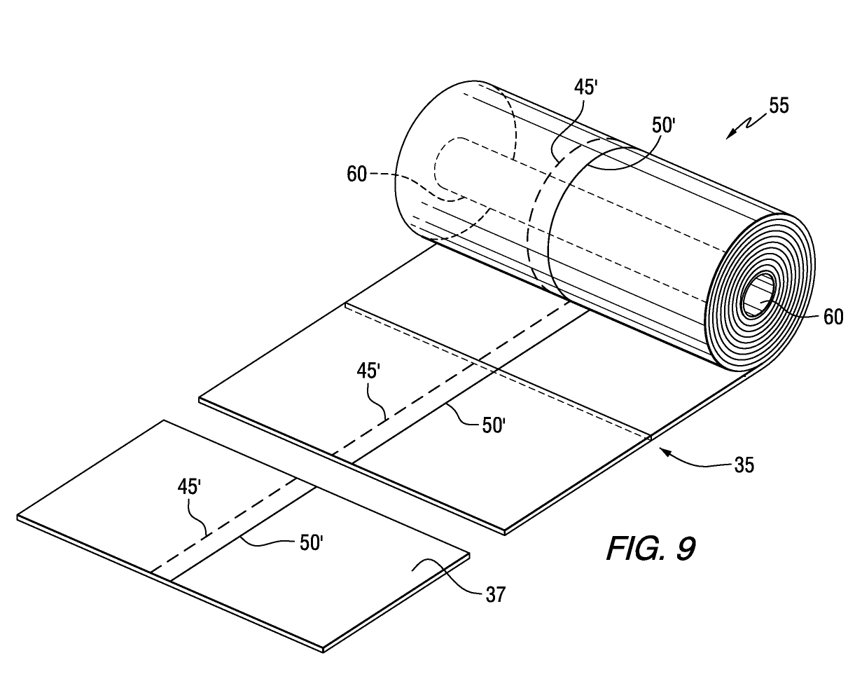

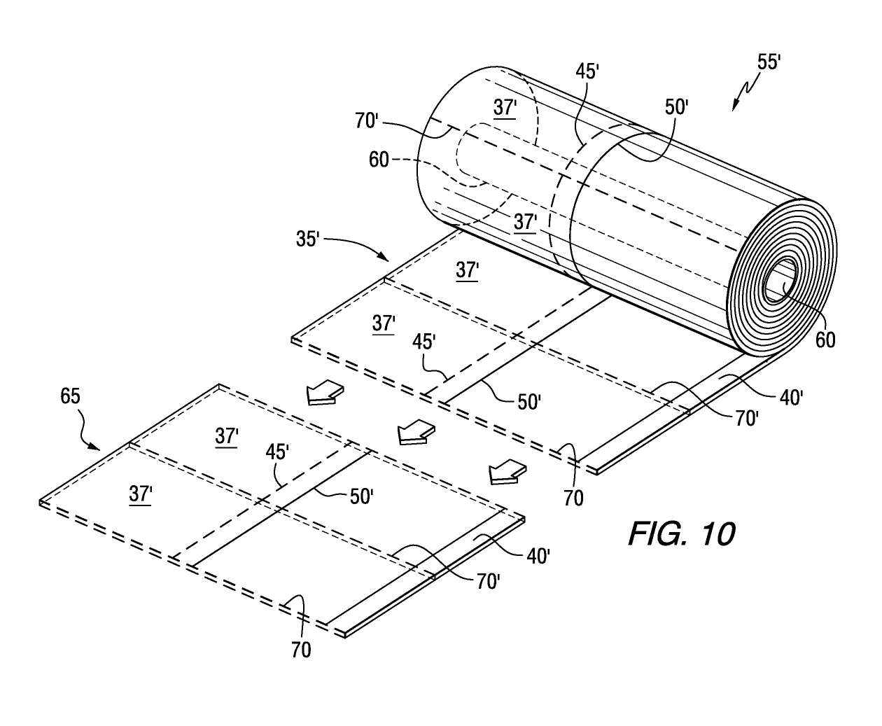

Referring now to FIG. 9 a roll 55 of wrappers 37 of any shape may be formed for easy manufacture and/or dispensing. A continuous strip of wrappers 37 is formed into a roll 55 such that individual wrappers 37 may be removed by the user. Preferably, the multi-sheet wrapper is wound about a hollow core 60 to form a roll 55. A section of wrapper 37 of any length may be removed from roll 55 by cutting with an appropriate cutting utensil, for instance scissors or a knife. Similar to the configuration discussed previously, roll 55 of wrappers 37 is provided with first perforation line 45′ which is typically aligned at the midpoint of and runs the length of the wrapper. Reference line 50′ is optionally applied to assist the user in locating first perforation line 45′. Referring now to FIGS. 9 and 10, adhesive strip 40′ may be affixed along at least one edge of roll 55 of wrappers 37 and is provided with a removable covering (not shown) in order to shield the adhesive material during application.

FIG. 10 illustrates an embodiment wherein the roll of wrappers 55′ comprises a continuous strip of wrappers 35′ with second perforation line 70 across the width and spaced at preset intervals such that individual wrappers 37′ may be removed by tearing along second perforation line 70. In this embodiment, multiple wrappers 37′ are connected together to form a strip wound into roll 55′. The user may select a length of connected wrappers 65 comprising more than one individual wrapper 37′ and containing one or more second perforation lines 70′ by tearing along second perforation line 70. This length of connected wrappers 65 may encircle roast 1 and then may be positioned for insertion into elastomeric net truss 25, as described in detail above. The user, through flexion of roast 1, may then cause longitudinal stress to be exerted along one side of roast 1 with respect to wrapper 65 at second perforation line 70′. This force is sufficient to separate second perforation line 70′, similar to that described in detail with reference to FIG. 7(B).

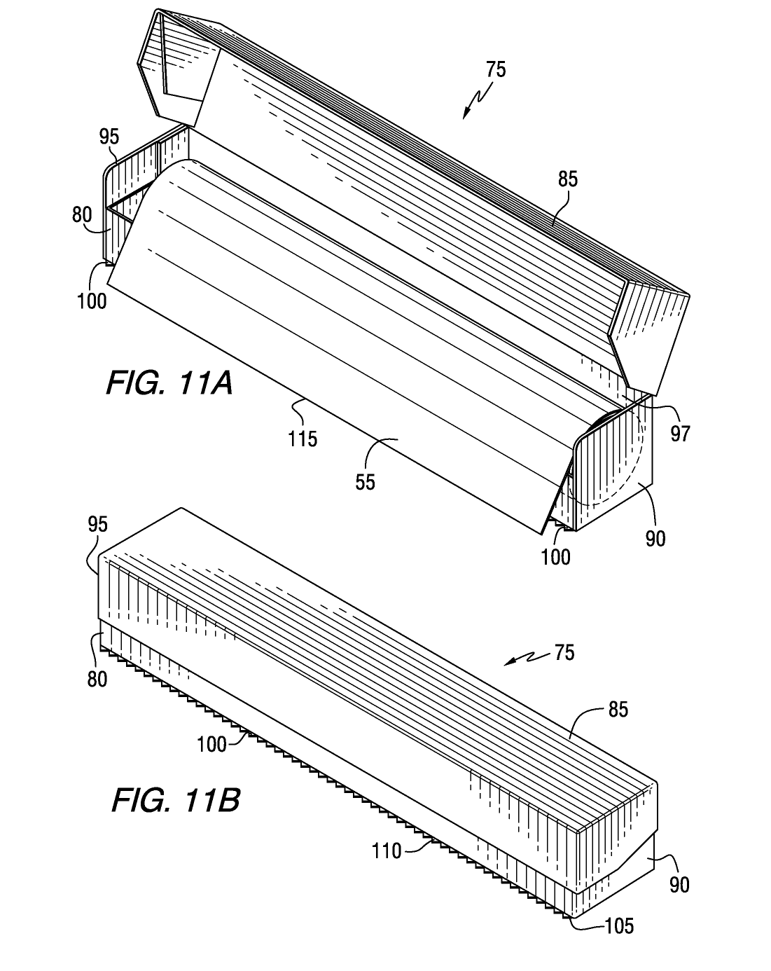

Referring now to FIGS. 11A and 11B, the roll of wrappers 55 is disposed within dispenser 75. FIG. 11A depicts the dispenser in the open configuration, while FIG. 11B depicts the dispenser in the closed configuration. In a preferred embodiment, dispenser 75 is manufactured from a paperboard or cardboard material. However, it is to be understood that dispenser 75 may be constructed from alternate materials such as plastic or wood. As illustrated in FIGS. 11A and 11B, dispenser 75 generally includes a base 80, a hinged lid 85 attached to base 80 and end flaps 90, 95. Hinged lid 85 is attached to base 80 such that it may easily open and close. Although dispenser 75 described herein is of a generally rectangular shape, it is to be understood that other shaped dispensers may be employed. Base 80, hinged lid 85 and end flaps 90, 95 are configured as illustrated in FIGS. 11A and 11B to produce open area or body 97. Body 97 is adapted to receive roll of wrappers 55 such that the roll 55 is partially or completely enclosed within body 97 depending on the open or closed configuration of hinged lid 85. Roll of wrappers 55 may be positioned for rotary movement within body 97. Such rotary movement allows for dispensing of a piece of wrapper 37 of any desired length (not shown in FIGS. 11A and 11B).

Dispenser 75 may also include cutting bar 100 comprising a series of serrations or teeth 110. In one embodiment, cutting bar 100 is located on base 80. Cutting bar 100 comprises a base 105 from which a plurality of teeth 110 extend outwards. As leading edge 115 of roll of wrappers 55 is pulled outward and away from dispenser 75, rotational force is exerted on roll 55, allowing the sheet of connected wrappers 37 to exit dispenser 75. With reference to FIGS. 11A and 11B, downward pressure exerted on sheet of connected wrappers 37 brings sheet 37 into contact with teeth 110 of cutting bar 100.

This force causes a length of wrappers 37 of any desirable length to detach from roll of wrappers 55. Cutting bar 100 may be constructed from a number of strong materials such as plastics or metal. In some situations, it may be desirable to provide cutting bar 100 in an alternate position. For example, cutting bar 100 may be located on hinged lid 85 (not shown). In this embodiment, the teeth of cutting bar 100 extend downward from lid 85 so that an upward force on sheet of connected wrappers 37 causes sheet 37 to come into contact with roll of cutting bar 100 when lid 85 is in a closed or partially closed position.

It is appreciated that various modifications to the inventive concepts may be apparent to those skilled in the art without departing from the spirit and scope of the invention.

What is claimed is:

1. A roll of wrapping material for receiving and retaining food products comprising a continuous strip of flexible material provided with a longitudinal perforation extending for the entire length of said roll, said perforation permitting the division of said wrapping sheet into at least two longitudinal sections.

2. The roll of claim 1 wherein said flexible material is selected from the group consisting of food grade plastic, collagen, biaxially oriented polypropylene, cellophane, polyethylene, silicone, coated fabric, Teflon, Mylar, vinyl wax, coated papers and a polymer.

3. The roll of claim 1 wherein said flexible material comprises plurality of a second perforation lines disposed entirely across the width of said wrapping sheet, said second perforation lines spaced at preset intervals.

4. The roll of claim 1 wherein said wrapping sheet further comprises an adhesive strip and a removable strip covering said adhesive strip, said adhesive strip and removable strip disposed on at least one side of said wrapping sheet entirely along the length of said roll.

5. A flexible food wrapper dispensing system comprising a roll of flexible material having a continuous longitudinal perforation extending thereon, disposed within a dispenser comprising a cutting bar.

6. The roll of claim 5 wherein said dispenser further comprises a cutting bar from which a plurality of teeth extend outwards.

7. The roll of claim 5 wherein said flexible material is selected from the group consisting of food grade plastic, collagen, biaxially oriented polypropylene, cellophane, polyethylene, silicone, coated fabric, Teflon, Mylar, vinyl wax, coated papers and a polymer.

8. The roll of claim 5 wherein said flexible material comprises plurality of a second perforation lines disposed entirely across the width of said wrapping sheet, said second perforation lines spaced at preset intervals.

9. A method of dispensing a continuous sheet of flexible material provided with at least one separable portion which permits the division of said sheet into at least two pieces, comprising:
forming a roll of said flexible material, said roll comprising a longitudinal perforation along its entire length separating said continuous sheet into at least two longitudinal sections.

10. The method of claim 9 further comprising providing at least one perforation line along the width of said roll.

11. The method of claim 10 further comprising the step of detaching a portion of said sheet at said perforation line.

12. The method of claim 9 further comprising the step of locating said continuous sheet of flexible material within a dispenser.

13. The method of claim 9 further comprising the step of exerting force on said continuous sheet of flexible material, thereby separating a length of said flexible material from said roll.

14. The method of claim 13 further comprising the step of contacting said sheet of flexible material with a plurality a teeth extending outward from said cutting bar.

15. The method of claim 13 further comprising the step of exerting force on said sheet of flexible material, thereby contacting said sheet with said cutting bar extending outward from at least one of a lid and the body of said dispenser.

16. The roll of claim 9 wherein said flexible material is selected from the group consisting of food grade plastic, collagen, biaxially oriented polypropylene, cellophane, polyethylene, silicone, coated fabric, Teflon, Mylar, vinyl wax, coated papers and a polymer.

17. The roll of claim 9 wherein said flexible material comprises plurality of a second perforation lines disposed entirely across the width of said wrapping sheet, said second perforation lines spaced at preset intervals.
